(19) United States
(12) Patent Application Publication
(10) Pub. No.: US 2022/0363202 A1
(43) Pub. Date: Nov. 17, 2022

(54) EXTERNALLY COUPLED LOUDSPEAKER ASSEMBLY FOR A VEHICLE

(71) Applicant: HARMAN INTERNATIONAL INDUSTRIES, INCORPORATED, Stamford, CT (US)

(72) Inventors: Patrick GROLEAU, Novi, MI (US); Alan Robert CROSS, Novi, MI (US)

(21) Appl. No.: 17/743,919

(22) Filed: May 13, 2022

Related U.S. Application Data
(60) Provisional application No. 63/188,523, filed on May 14, 2021.

(51) Int. Cl. B60R 11/02; H04R 5/02; H04R 1/02; H04R 1/32

(52) U.S. Cl. CPC B60R 11/0217; H04R 5/02; H04R 1/025; H04R 1/323; H04R 1/023; H04R 2499/13; H04R 2400/11

(57) ABSTRACT

A loudspeaker assembly for a vehicle includes a loudspeaker having a first side facing a vehicle interior and an opposed second side, wherein the loudspeaker is configured to generate an acoustical signal having a rear wave directed into the vehicle interior and a front wave directed away from the vehicle interior toward a vehicle exterior. A motor assembly is on the first side of the loudspeaker, and a diaphragm is at the second side of the loudspeaker for generating the rear wave and the front wave. The loudspeaker assembly includes a bracket into which the loudspeaker is mounted, the bracket including a basket for receiving and supporting the motor assembly, and a coupler disposed on the second side of the loudspeaker and extending toward the vehicle exterior, wherein the coupler is arranged to transmit the front wave to the vehicle exterior.

### CROSS-REFERENCE TO RELATED APPLICATIONS

This application claims the benefit of U.S. provisional application Ser. No. 63/188,523 filed May 14, 2021, the disclosure of which is hereby incorporated in its entirety by reference herein.

### TECHNICAL FIELD

Embodiments relate to an externally coupled loudspeaker assembly for a vehicle.

### BACKGROUND

Automotive audio systems typically include several loudspeakers positioned in various locations within the interior of a vehicle, such as the passenger compartment or the trunk. Typical loudspeaker positions may include door panels or interior trim panels. Low-frequency loudspeakers, also known as woofers or subwoofers, are often located in the trunk, the rear panel shelf, under the rear seats, the chassis or in other frame elements of a vehicle.

In an externally coupled subwoofer (ECS), the loudspeaker housing may be omitted because the front and the back side of the loudspeaker are isolated from each other by a vehicle panel or frame element. In acoustical terms, an ECS configuration is referred to as an “infinite baffle”, allowing optimized low frequency extension and maximized bandwidth, while simultaneously eliminating the requirement for a large sealed or vented-box subwoofer enclosure. This approach provides a very compact and weight efficient arrangement for audio inside the vehicle without sacrificing acoustical performance.

Typical ECS configurations include a metal or plastic frame which supports the loudspeaker, and a rear enclosure or coupler which connects to the frame and vents audio waves from the rear of the loudspeaker to the outside of the vehicle. The volume of the coupler is generally much larger than the speaker volume, which may undesirably decrease the tuning frequency of the coupler and limit the frequency range available for the loudspeaker.

### SUMMARY

In one or more embodiments, a loudspeaker assembly for a vehicle includes a loudspeaker having a first side facing a vehicle interior and an opposed second side, wherein the loudspeaker is configured to generate an acoustical signal having a rear wave directed into the vehicle interior and a front wave directed away from the vehicle interior toward a vehicle exterior. A motor assembly is on the first side of the loudspeaker, and a diaphragm is at the second side of the loudspeaker for generating the rear wave and the front wave. The loudspeaker assembly includes a bracket into which the loudspeaker is mounted, the bracket including a basket for receiving and supporting the motor assembly, and a coupler disposed on the second side of the loudspeaker and extending toward the vehicle exterior, wherein the coupler is arranged to transmit the front wave to the vehicle exterior.

In one or more embodiments, the basket may be integral with the bracket. The coupler may include an inlet portion disposed adjacent to the second side of the loudspeaker, an outlet portion in fluid communication with the vehicle exterior, and a duct extending between the inlet portion and the outlet portion. The inlet portion may have a larger cross-sectional area than the duct, such that the coupler decreases in cross-section from the inlet portion to the outlet portion. The inlet portion may have a generally oval or circular configuration to correspond with a configuration of the second side of the loudspeaker. The inlet portion may include one or more mounting tabs extending therefrom for fastening the coupler to the bracket.

In one or more embodiments, the outlet portion may be arranged to be received in an opening of a vehicle body panel. The outlet portion may include a gasket for interfacing and sealing with the vehicle body panel. The outlet portion may include a screen to prevent debris from entering the coupler. A cross-sectional area of the duct may be variable along a length of the duct. The bracket may include one or more mounting arms extending therefrom for fastening the bracket to a vehicle body panel or a frame element of the vehicle. A volume of the coupler may be substantially similar to a volume of the loudspeaker. The loudspeaker may be a subwoofer or a woofer.

In one or more embodiments, an externally coupled loudspeaker assembly for a vehicle includes a loudspeaker having a first side facing a vehicle interior and an opposed second side, wherein the loudspeaker is configured to generate an acoustical signal having a rear wave directed into the vehicle interior and a front wave directed away from the vehicle interior toward a vehicle exterior, the loudspeaker comprising a subwoofer or a woofer. A motor assembly is on the first side of the loudspeaker, and a diaphragm is at the second side of the loudspeaker for generating the rear wave and the front wave. The loudspeaker assembly includes a bracket into which the loudspeaker is mounted, the bracket including an integrally formed basket for receiving and supporting the motor assembly. The loudspeaker assembly further includes a coupler disposed on the second side of the loudspeaker and extending toward the vehicle exterior, the coupler including an inlet portion disposed adjacent to the second side of the loudspeaker, an outlet portion in fluid communication with the vehicle exterior, and a duct extending between the inlet portion and the outlet portion, wherein the coupler is arranged to transmit the front wave to the vehicle exterior.

In one or more embodiments, an audio system for a vehicle includes at least one loudspeaker assembly including a loudspeaker having a first side facing a vehicle interior and an opposed second side, wherein the loudspeaker is configured to generate an acoustical signal having a rear wave directed into the vehicle interior and a front wave directed away from the vehicle interior toward a vehicle exterior. A motor assembly is on the first side of the loudspeaker, and a diaphragm is at the second side of the loudspeaker for generating the rear wave and the front wave. The loudspeaker assembly includes a bracket into which the loudspeaker is mounted, the bracket including a basket for receiving and supporting the motor assembly, and a coupler disposed on the second side of the loudspeaker and extending toward the vehicle exterior, wherein the coupler is arranged to transmit the front wave to the vehicle exterior. The audio system further includes a control unit in electrical communication with the at least one loudspeaker assembly for controlling parameters of the loudspeaker and the generated acoustic signal.

### BRIEF DESCRIPTION OF THE DRAWINGS

FIG. 1 is a schematic illustration of an externally coupled loudspeaker mounted in a baffle to generate a front sound wave into the interior of a vehicle and a rear sound wave to the exterior of the vehicle;

FIG. 2 is an exploded view of a loudspeaker assembly according to one or more embodiments including a bracket having an integrated basket and a coupler for venting the front wave from a second side of the loudspeaker to a vehicle exterior;

FIG. 3 is a perspective view of the assembled loudspeaker assembly;

FIG. 4 is another perspective view of the assembled loudspeaker assembly;

FIG. 5 is a front view of the assembled loudspeaker assembly;

FIG. 6 is an illustration of the loudspeaker assembly mounted in a vehicle according to one or more embodiments;

FIG. 7 is a cross-sectional view of the loudspeaker assembly mounted in a vehicle;

FIG. 8 is another cross-sectional view of the loudspeaker assembly mounted in a vehicle;

FIG. 9 is a graph of the frequency response of subwoofers measured under infinite baffle conditions, in a conventional ECS configuration, and in the ECS configuration according to the embodiments disclosed herein; and

FIG. 10 is a schematic illustration of a vehicle showing a loudspeaker assembly according to one or more embodiments connecting a second side of the loudspeaker to the exterior of the vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

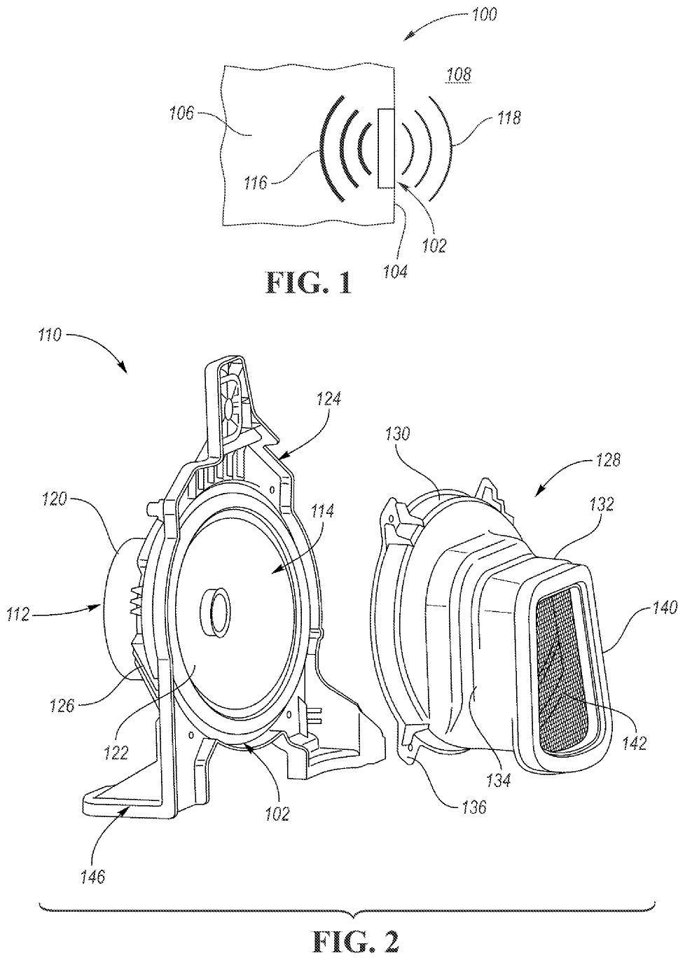

Referring first to FIG. 1, a schematic illustration of a vehicle 100 with a loudspeaker 102 mounted therein is shown. In this illustration, the loudspeaker 102 is arranged in a baffle 104, such as a vehicle body panel, which forms a barrier between the vehicle interior 106 and the vehicle exterior 108. The baffle 104 may include an opening or cavity in which the loudspeaker 102 is arranged. In one or more embodiments, the loudspeaker 102 may be a subwoofer or a woofer and may be part of an automotive audio system. It is understood that an automotive audio system may comprise several loudspeakers, although only one loudspeaker 102 is exemplarily illustrated herein.

Loudspeakers, such as subwoofers or woofers, that provide low-frequency sound require a large enclosure volume. In general, subwoofers generally emit sound between 20 Hz and 200 Hz, while traditional woofers generally emit sound between 40 Hz and 400 Hz. If the loudspeaker 102 is positioned in the frame or chassis of the vehicle 100 between the vehicle interior 106 and the vehicle exterior 108, an otherwise necessary loudspeaker housing may be omitted.

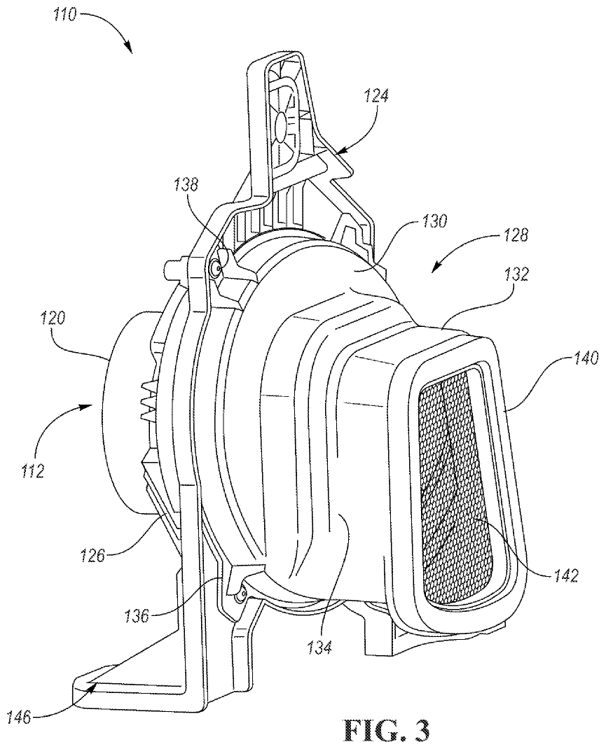

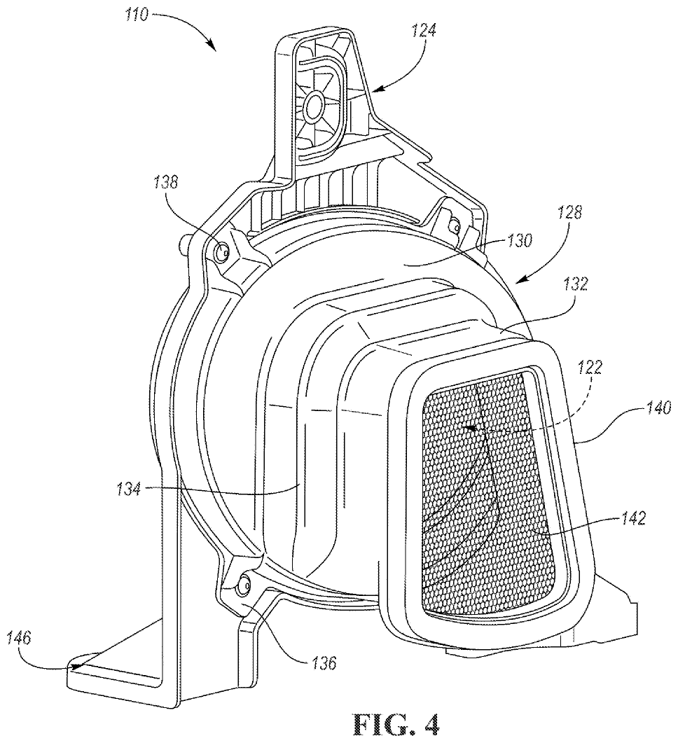

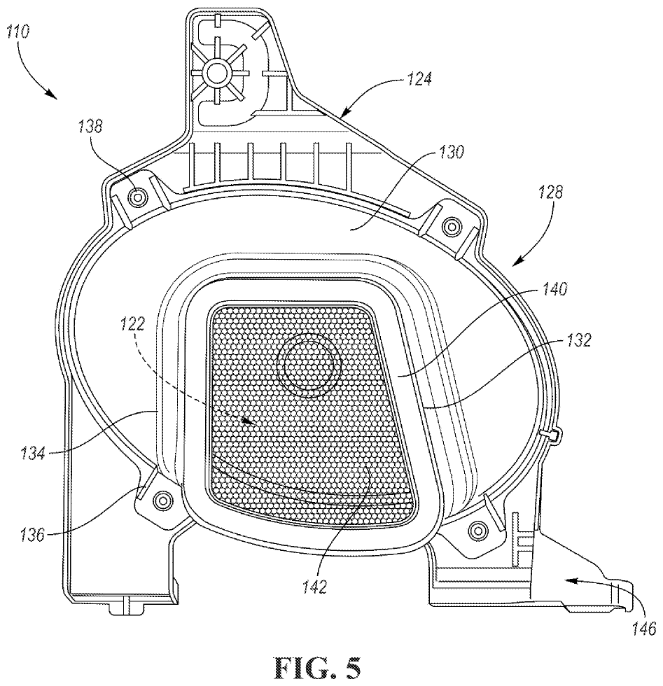

With reference to FIGS. 2-5, a loudspeaker assembly 110 for a vehicle 100 according to one or more embodiments includes a loudspeaker 102 having a first side 112 facing the vehicle interior 106 and an opposed second side 114. The loudspeaker 102 is configured to generate an acoustical signal having a rear wave 116 (FIG. 1) directed into the vehicle interior 106 and a front wave 118 (FIG. 1) directed away from the vehicle interior 106 and toward the vehicle exterior 108. The first side 112 of the loudspeaker 102 includes a motor assembly 120 and the second side 114 of the loudspeaker 102 includes a diaphragm or cone 122 for generating the rear wave 116 and the front wave 118. The cone 122 may be formed of paper, paper composites/laminates, plastic such as polypropylene or mineral/fiber-filled polypropylene, or other suitable materials.

The loudspeaker assembly 110 further includes a bracket 124 into which the loudspeaker 102 is mounted. In one or more embodiments, the bracket 124 includes an integrated basket 126 for receiving and supporting the motor assembly 120. The integrated bracket 124 and basket 126 may be constructed from a metallic or plastic material, for example. Alternatively, the basket 126 may be attached to the bracket 124, such as by fasteners or adhesive, and separable therefrom.

With continuing reference to FIGS. 2-5, the loudspeaker assembly 110 includes a coupler 128 disposed on the second side 114 of the loudspeaker 102 and extending toward the vehicle exterior 108. The coupler 128 is arranged to transmit the front wave 118 to the vehicle exterior 108. The coupler 128 comprises an inlet portion 130 disposed adjacent to the second side 114 of the loudspeaker 102, an outlet portion 132 in fluid communication with the vehicle exterior 108, and a duct 134 extending between the inlet portion 130 and the outlet portion 132. As shown, the inlet portion 130 may have a generally oval or circular configuration to correspond with a configuration of the second side 114 of the loudspeaker 102, but other shapes such as rectangular or square configurations are also contemplated. The inlet portion 130 may include one or more mounting tabs 136 extending therefrom through which fasteners 138 can be used to fasten the coupler 128 to the bracket 124. Alternatively, the inlet portion 130 could be secured to the bracket 124 with adhesive or by another method.

The duct 134 may have a generally rectangular cross-section as shown or may have a circular or other cross-sectional shape, and the cross-sectional area of the duct 134 may be variable along its length. In one or more embodiments, the inlet portion 130 may have a larger cross-sectional area than the duct 134, such that the coupler 128 decreases in cross-section from the inlet portion 130 to the outlet portion 132. The outlet portion 132 may be generally rectangular as shown or have other shapes and sizes. The outlet portion 132 may include a gasket 140 for interfacing and sealing with a vehicle body panel, and may also include a screen 142 to prevent debris from entering the coupler 128. The coupler 128 can be constructed from a rigid or flexible material, such as a plastic, metallic, or other suitable material.

In previous ECS configurations, the loudspeaker 102 is oriented such that the second side 114 including the cone 122 faces the vehicle interior 106 and the first side 112 including the motor assembly 120 faces the vehicle exterior 108. In these typical ECS configurations, the volume of the coupler 128 had to be large enough to accommodate the basket 126 on the first side 112 of the loudspeaker 102. In contrast, in the embodiments disclosed herein, the loudspeaker 102 is oriented such that the second side 114 including the cone 122 faces the opposite direction, toward the vehicle exterior 108, whereas the first side 112 with the motor assembly 120 and the basket 126 faces the vehicle interior 106.

By orienting the loudspeaker 102 with the motor assembly 120 facing the vehicle interior 106, the coupler 128 does not need to have such a large volume, as it no longer needs to accommodate the basket 126. The volume of the coupler 128 may remain larger than the volume of the loudspeaker 102, but the volume of the coupler 128 may now be reduced to more closely match the volume of the loudspeaker 102, allowing for a closer ratio of speaker volume to coupler volume. As a result of this optimization of the volume ratio where the volume of the coupler 128 is substantially similar to the volume of the loudspeaker 102, the tuning frequency of the coupler 128 is increased, providing an improved acoustic performance of the loudspeaker 102 and acoustic flexibility of the loudspeaker assembly 110. In addition, the volume and the length of the coupler 128 may be manipulated to adjust and control the tuning frequency of the coupler 128 and the loudspeaker assembly 110. This control provides the ability to push or pull the tuning frequency across a larger band, allowing for sufficient output at higher playing ranges and thereby providing versatility in the type of loudspeaker 102 (e.g. woofer in addition to subwoofer) that can be implemented in the loudspeaker assembly 110.

In the embodiments disclosed herein, reducing the overall size and mass of the coupler 128 compared to conventional ECS configurations advantageously decreases the cost of the loudspeaker assembly 110. The number of components in the loudspeaker assembly 110 may also be reduced compared to typical ECS configurations, such as with integration of the basket 126 into the bracket 124. The integration of components reduces the number of separate components in the loudspeaker assembly 110 which, in turn, reduces cost and simplifies the assembly process. While particular configurations of the coupler 128 and the integrated bracket 124 and basket 126 are shown and described herein, it is understood that the coupler 128, bracket 124 and basket 126 are not limited to these configurations, and that other geometries, lengths, and areas of these components are contemplated and may be selected to optimize transmission of the acoustical signal to the interior of a specific vehicle.

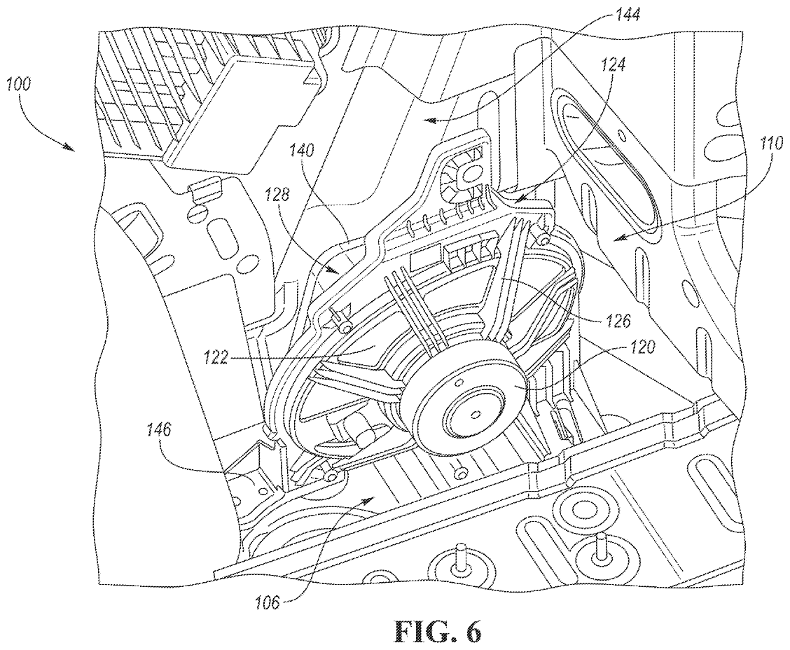

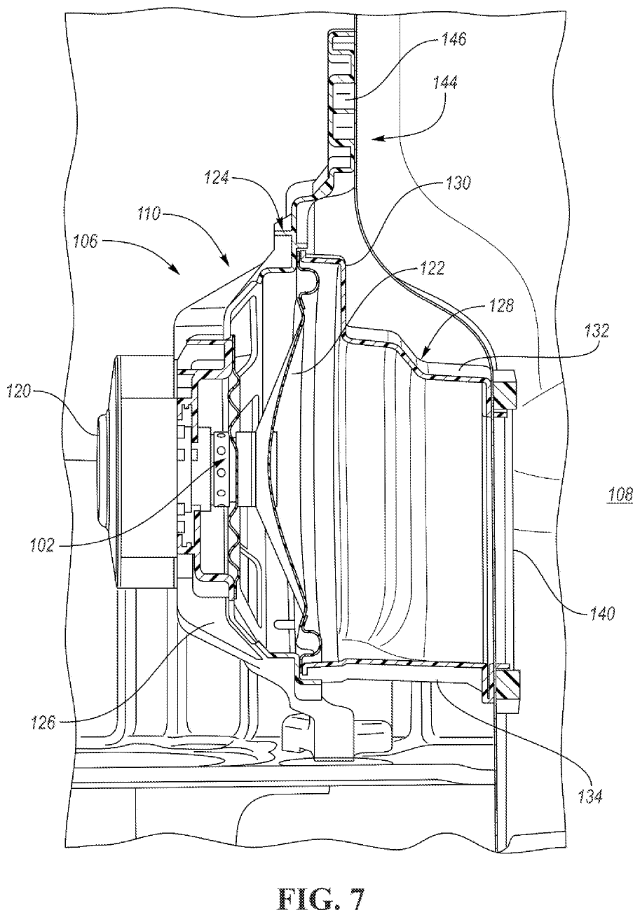

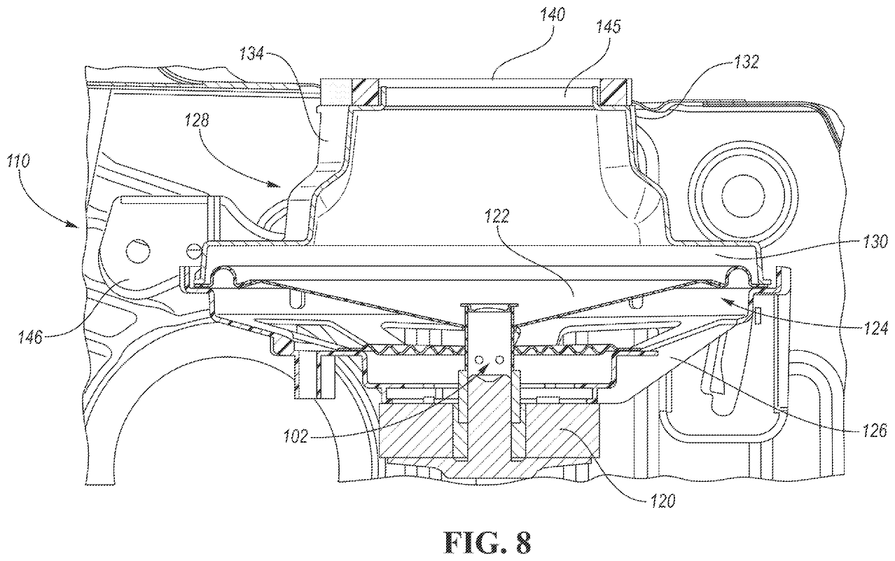

FIGS. 6-8 illustrate an exemplary mounting position of the loudspeaker assembly 110 in a vehicle 100, such as in the trunk adjacent to a rear quarter panel. The bracket 124 is arranged to be mounted to a vehicle body panel 144 such that the first side 112 of the loudspeaker 102 faces the vehicle interior 106. A speaker grill (not shown) may cover the first side 112 of the loudspeaker 102 and may be visible from the vehicle interior 106. The coupler 128 may be structured to fluidly connect a second side 114 of the loudspeaker 102 to an opening 145 in a vehicle body panel 144 with which the outlet portion 132 and gasket 140 may interface. The bracket 124 may include one or more mounting arms 146 extending therefrom for fastening the bracket 124 to a vehicle body panel 144 or frame element of the vehicle 100. While the loudspeaker assembly 110 is shown and described herein as being mounted in the vehicle interior 106, alternatively the loudspeaker assembly 110 could be packaged on the vehicle exterior 108 with the coupler 128 directed toward the vehicle interior 106. In addition, while mounting of the loudspeaker assembly 110 is shown and described herein with respect to an automobile, it is understood that implementation of the loudspeaker assembly 110 in other types of vehicles is also fully contemplated.

When the second side 114 of the loudspeaker 102 is in fluid communication with the atmosphere on the vehicle exterior 108, the loudspeaker 102 is considered to have an infinite baffle. One benefit of having the second side 114 in fluid communication with the open atmosphere is that undesirable resonances in the loudspeaker 102 may be reduced because sound waves emitted from the second side 114 of the loudspeaker 102 do not interfere with sound waves emitted from the first side 112 of the loudspeaker 102. Additionally, another benefit of the open environment, or infinite baffle, is that strain in the cone 122 is reduced because the second side 114 of the loudspeaker 102 vents to the outside atmosphere. As a result, the loudspeaker 102 may produce a higher sound pressure level (SPL) at low frequency ranges in the vehicle interior 106.

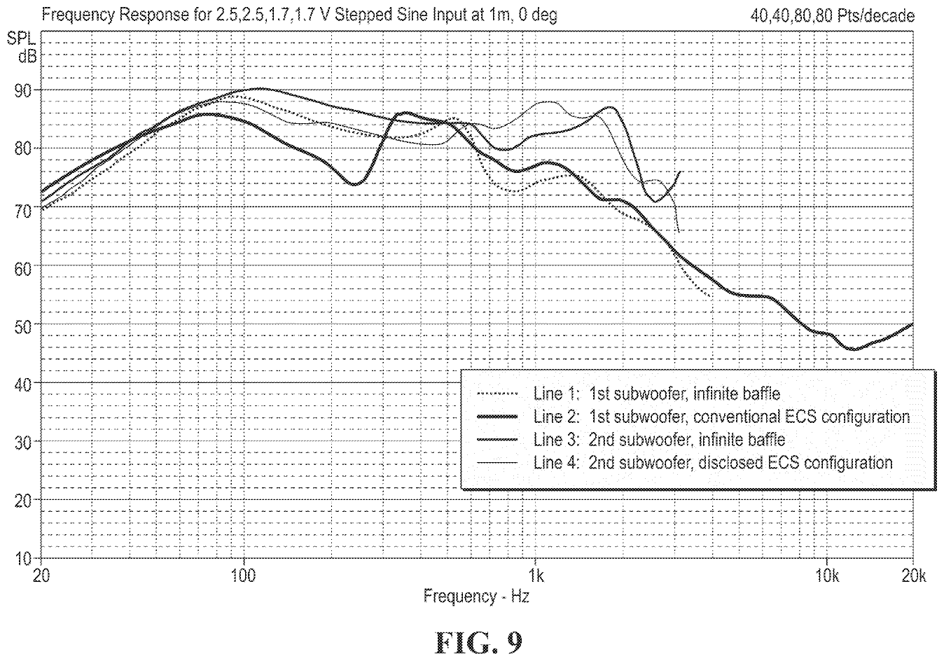

With reference to FIG. 9, a graph of the frequency response (SPL as a function of frequency) of different infinite baffle and ECS configurations is shown. Line 1 represents the frequency response of a first subwoofer in an infinite baffle condition, whereas Line 2 is the first subwoofer in a conventional ECS configuration. Below 100 Hz, part of the normal operating range for a subwoofer, the conventional ECS configuration has a loss of output of about 5 dB as compared to the infinite baffle condition. As the frequency increases beyond 100 Hz to about 280 Hz, the conventional ECS configuration displays further acoustic resistance or impedance loss which reduces the output of the first subwoofer compared to the infinite baffle condition to a much greater extent.

In comparison, Line 3 in the graph of FIG. 9 represents a second subwoofer in an infinite baffle condition, whereas Line 4 is the second subwoofer included in the ECS configuration disclosed herein (loudspeaker assembly 110). As shown, below 100 Hz, the disclosed ECS configuration does not result in an SPL loss of more than 1 dB as compared to the infinite baffle condition. Above 100 Hz, the SPL loss is greatly reduced as compared to the conventional ECS configuration. This sustained output performance at higher frequencies provides versatility by allowing for the use of a woofer with the loudspeaker assembly 110 as an alternative to a subwoofer.

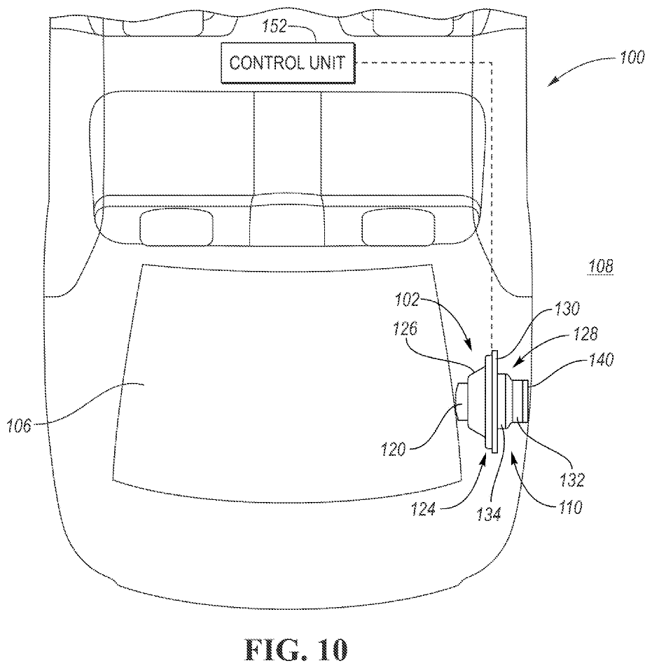

As illustrated schematically in FIG. 10, the vehicle 100 may include a control unit 152 that is in electrical communication with the loudspeaker assembly 110, including the loudspeaker 102 and any other loudspeakers included in the automotive audio system. The control unit 152 may be used for controlling various parameters of the loudspeaker 102 and the resulting acoustical signal.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A loudspeaker assembly for a vehicle, comprising:
a loudspeaker having a first side facing a vehicle interior and an opposed second side, wherein the loudspeaker is configured to generate an acoustical signal having a rear wave directed into the vehicle interior and a front wave directed away from the vehicle interior toward a vehicle exterior;
a motor assembly on the first side of the loudspeaker;
a diaphragm at the second side of the loudspeaker for generating the rear wave and the front wave;
a bracket into which the loudspeaker is mounted, the bracket including a basket for receiving and supporting the motor assembly; and
a coupler disposed on the second side of the loudspeaker and extending toward the vehicle exterior, wherein the coupler is arranged to transmit the front wave to the vehicle exterior.

2. The loudspeaker assembly of claim 1, wherein the basket is integral with the bracket.

3. The loudspeaker assembly of claim 1, wherein the coupler includes an inlet portion disposed adjacent to the second side of the loudspeaker, an outlet portion in fluid communication with the vehicle exterior, and a duct extending between the inlet portion and the outlet portion.

4. The loudspeaker assembly of claim 3, wherein the inlet portion has a larger cross-sectional area than the duct, such that the coupler decreases in cross-section from the inlet portion to the outlet portion.

5. The loudspeaker assembly of claim 3, wherein the inlet portion has a generally oval or circular configuration to correspond with a configuration of the second side of the loudspeaker.

6. The loudspeaker assembly of claim 3, wherein the inlet portion includes one or more mounting tabs extending therefrom for fastening the coupler to the bracket.

7. The loudspeaker assembly of claim 3, wherein the outlet portion is arranged to be received in an opening of a vehicle body panel.

8. The loudspeaker assembly of claim 7, wherein the outlet portion includes a gasket for interfacing and sealing with the vehicle body panel.

9. The loudspeaker assembly of claim 3, wherein the outlet portion includes a screen to prevent debris from entering the coupler.

10. The loudspeaker assembly of claim 3, wherein a cross-sectional area of the duct is variable along a length of the duct.

11. The loudspeaker assembly of claim 1, wherein the bracket includes one or more mounting arms extending therefrom for fastening the bracket to a vehicle body panel or a frame element of the vehicle.

12. The loudspeaker assembly of claim 1, wherein a volume of the coupler is substantially similar to a volume of the loudspeaker.

13. The loudspeaker assembly of claim 1, wherein the loudspeaker is a subwoofer or a woofer.

14. An externally coupled loudspeaker assembly for a vehicle, comprising:
a loudspeaker having a first side facing a vehicle interior and an opposed second side, wherein the loudspeaker is configured to generate an acoustical signal having a rear wave directed into the vehicle interior and a front wave directed away from the vehicle interior toward a vehicle exterior, the loudspeaker comprising a subwoofer or a woofer;
a motor assembly on the first side of the loudspeaker;
a diaphragm at the second side of the loudspeaker for generating the rear wave and the front wave;
a bracket into which the loudspeaker is mounted, the bracket including an integrally formed basket for receiving and supporting the motor assembly; and
a coupler disposed on the second side of the loudspeaker and extending toward the vehicle exterior, the coupler including an inlet portion disposed adjacent to the second side of the loudspeaker, an outlet portion in fluid communication with the vehicle exterior, and a duct extending between the inlet portion and the outlet portion, wherein the coupler is arranged to transmit the front wave to the vehicle exterior.

15. The loudspeaker assembly of claim 14, wherein the inlet portion has a larger cross-sectional area than the duct, such that the coupler decreases in cross-section from the inlet portion to the outlet portion.

16. The loudspeaker assembly of claim 14, wherein the inlet portion has a generally oval or circular configuration to correspond with a configuration of the second side of the loudspeaker.

17. The loudspeaker assembly of claim 14, wherein the outlet portion is arranged to be received in an opening of a vehicle body panel, the outlet portion including a gasket for interfacing and sealing with the vehicle body panel.

18. The loudspeaker assembly of claim 14, wherein a cross-sectional area of the duct is variable along a length of the duct.

19. The loudspeaker assembly of claim 14, wherein a volume of the coupler is substantially similar to a volume of the loudspeaker.

20. An audio system for a vehicle, comprising:
at least one loudspeaker assembly including
a loudspeaker having a first side facing a vehicle interior and an opposed second side, wherein the loudspeaker is configured to generate an acoustical signal having a rear wave directed into the vehicle interior and a front wave directed away from the vehicle interior toward a vehicle exterior;
a motor assembly on the first side of the loudspeaker;
a diaphragm at the second side of the loudspeaker for generating the rear wave and the front wave;
a bracket into which the loudspeaker is mounted, the bracket including a basket for receiving and supporting the motor assembly; and
a coupler disposed on the second side of the loudspeaker and extending toward the vehicle exterior, wherein the coupler is arranged to transmit the front wave to the vehicle exterior; and
a control unit in electrical communication with the at least one loudspeaker assembly for controlling parameters of the loudspeaker and the generated acoustic signal.
